(19) United States
(12) Patent Application Publication
(10) Pub. No.: US 2024/0143962 A1
(43) Pub. Date: May 2, 2024

(54) Sports Memorabilia

(71) Applicant: Daniel J. Flynn, Weymouth, MA (US)

(72) Inventor: Daniel J. Flynn, Weymouth, MA (US)

(21) Appl. No.: 18/495,018

(22) Filed: Oct. 26, 2023

Related U.S. Application Data
(60) Provisional application No. 63/381,632, filed on Oct. 31, 2022.

(51) Int. Cl. G06K 15/02

(52) U.S. Cl. CPC G06K 15/024; G06K 15/1843

(57) ABSTRACT

A sports memorabilia is provided having visual images of highlights and important moments of an athlete's career and/or experience applied to an equipment used in the sport played by the athlete. Visual images applied to the sports equipment may be photographs, drawings, paintings, renderings, and the like without straying from the scope of the invention. In a particular embodiment, the present disclosure may involve a method of producing and applying the visual images to the equipment via a vinyl or other polymer wrap.

### BACKGROUND OF THE INVENTION

The present disclosure relates generally to sports memorabilia. More particularly the present disclosure relates to sports memorabilia in the form of sports equipment (sticks, bats, balls, helmets, bags, gloves, and so on) having a visual design applied onto the equipment which shows images relating to a particular player's career and/or sporting experience.

Sports memorabilia has long held a special place in the hearts of fans, collectors, and enthusiasts alike. The traditional forms of sports memorabilia have primarily included items such as trading cards, jerseys, autographed photographs, and other physical mementos associated with athletes and their accomplishments. While these forms of memorabilia have served their purpose admirably, there has been a growing demand for a more immersive and dynamic means of commemorating the careers of beloved athletes.

Therefore, what is needed is a sports memorabilia and systems for making this memorabilia which can tell a story and depict important events of the athlete's career.

### SUMMARY OF THE INVENTION

The subject matter of this application may involve, in some cases, interrelated products, alternative solutions to a particular problem, and/or a plurality of different uses of a single system or article.

In one aspect, a sports equipment is provided. The sports equipment has a body shaped to define the structure of the particular item. The body varies in shape having different widths and lengths, such as a traditional hockey stick, baseball bat, and the like. A polymer layer is applied to a surface of the body and is wrapped around the body and adhered there to. The polymer layer has depictions relating to a particular player such as photographs or images (drawings, paintings, sketches, and so on) as well as optionally statistics, player name, dates, key events, and the like.

In another aspect, a computerized system for creating a composition of images depicting a career of an athlete for disposition on an item of sports equipment is provided. The system includes a computing device which has a memory and a processor. The memory stores instructions and the processor is operable to execute the instructions. The system has a user interface which is connected to the computing device. The processor is operable to cause the system to receive input image data (i.e. photos, drawings, sketches, and the like), receive an arrangement suggestion (i.e. a user can arrange these images, graphics, and text relative to each other in a manner the user desires as a suggestion and starting point for the system, on the user interface display), and receive a sports equipment type selection (i.e. a hockey stick, a baseball bat, a basketball, and so on). The system may then be operable to combine the received input image data and arrangement suggestion into a first image data file and store this file to the memory. The system may then apply one or more transformations using transformation algorithms to the first image data file which creates a second image data file based on the received sports equipment type selection. The second image data file is modified/transformed in shape from the first image data file to fit on the sports equipment and the individual graphics of the first image data file are scaled, shaped, cropped, and/or rearranged to fit on the item of sports equipment. The second image data file is then saved to the memory for later use.

In yet another aspect, a method of use of the system may involve compiling art work into a first image file, applying the above noted transformations to the first image file to create a second image file, and then printing this second image file. The printing may be onto a polymer sheet for disposition on the sports equipment item, may be directly disposed on the item, or the like.

### BRIEF DESCRIPTION OF DRAWINGS

FIG. 1 provides a view of one embodiment of the present disclosure.

FIG. 2 provides a view of another embodiment of the present disclosure.

FIG. 3 provides a view of yet another embodiment of the present disclosure.

FIG. 4 provides a view of an embodiment of a sheet for disposition on an item of sports equipment.

FIG. 5 provides a view of another embodiment of a sheet for disposition on an item of sports equipment.

FIG. 6 provides a view of yet another embodiment of a sheet for disposition on an item of sports equipment.

FIG. 7 provides a view of still another embodiment of a sheet for disposition on an item of sports equipment.

FIG. 8 provides a flow chart of an embodiment of the presently disclosed system.

### DETAILED DESCRIPTION OF THE INVENTION

The detailed description set forth below in connection with the appended drawings is intended as a description of presently preferred embodiments of the invention and does not represent the only forms in which the present disclosure may be constructed and/or utilized. The description sets forth the functions and the sequence of steps for constructing and operating the invention in connection with the illustrated embodiments.

The present disclosure is directed to sports memorabilia in the form of sports equipment (sticks, bats, balls, helmets, bags, gloves, and so on) having a visual design applied onto the equipment which shows images relating to a particular player's career and/or sporting experience. This may apply to professional and/or amateur athletes. The term sports equipment is used herein to broadly mean any item which is used in a particular sport and/or bags, carriers, vehicles (for auto sports such as a NASCAR® vehicle wrap), and the like related to the sport. The present invention is disclosed herein with regard to specific embodiments applied to sticks, bats, balls, gloves, and the like, but of course may be applied to any other sports equipment without straying from the scope of this invention. The sports equipment may be equipment actually used in a sporting event such as a game-used hockey stick, or may be unused and standard sized. In other embodiments these sports equipment products may have various sizes such as full size, child size, miniature display size, and the like.

The subject of the present disclosure addresses the demand noted above by introducing a distinctive approach to sports memorabilia, whereby highlights of a player's career are visually displayed in a manner that captures the essence of their journey, achievements, and contributions to their respective sport. This unique memorabilia goes beyond the conventional autograph or photograph and immerses fans and collectors in a multi-dimensional representation of the player's career, creating a more profound and engaging connection.

The innovation presented in this application may, in many embodiments, focus on the transformation of traditional sports memorabilia into dynamic visual displays that depicts the player's career highlights. These visual displays encompass a wide range of elements that are central to the player's journey, including but not limited to: Iconic Moments: The invention captures and showcases the most iconic moments from the player's career, such as game-winning plays, record-breaking achievements, and historic events. Career Milestones: Career milestones, such as individual and team achievements, awards, and significant statistical accomplishments, are prominently featured. Player's Profile: The memorabilia may include a visual representation of the player, their signature, and other personal details that enhance the connection between the fan and the athlete. Team Affiliations: The player's association with different teams, along with team logos, colors, and emblems, is visually portrayed to celebrate their career progression. Career Evolution: The memorabilia may present a chronological depiction of the player's journey, allowing fans to relive the evolution of their skills and contributions over time.

This present disclosure is not limited to specific sports or players but is designed to be adaptable to a wide range of athletes and sports, ensuring its universal appeal to sports enthusiasts. Further, the inventive sports memorabilia may be applicable to both professional athletes as well as amateur athletes and youth sports.

As seen in the figures, sports memorabilia contemplated herein has visual markings and demonstrations of highlights of a player's career. This may include numbers, teams, logos, and the like, as well as one or more images of the athlete. Locations, nicknames, defining events, awards, and highlights are also preferably included. In a particular embodiment, the visual depictions of the player's career and/or experience may be presented in a time-wise manner such that an early career elements are on one side and later career elements proceed in a linear fashion. The figures show a series of embodiments of the invention on hockey sticks, balls, gloves, and the like. As noted, of course other sports equipment may be used without straying from the scope of this invention.

In one embodiment of assembly of the present disclosure, a multi-step process may be employed. Initially, a visual depiction may be created, this may be in the form of a digital or physical artwork, photographs, combinations of artwork and photos, and the like. The visual depiction may then be stored as a digital data file such as an image file. This image file may then be printed or otherwise disposed onto a film material such as a vinyl wrap, or other polymer wrap, fabric, and the like, hereinafter referred to as a “wrap”. The printed wrap may then be applied to the sports equipment using disposition methods for adhering and/or bonding the wrap to the sports equipment. In one embodiment, the wrap may be a vinyl wrap which then may be heat-shrunk around the sports equipment to bond it to the sports equipment. In a particular embodiment, the printed visual depiction on the wrap may be stretched and expanded so as to appear the proper size and scale once shrunk to the appropriate size when applied to the equipment. For example, if being applied to a hockey stick, the visual depictions may be slightly larger so that when shrunk they look appropriate. Areas to be applied to the more narrow neck of the stick may be blown up more than areas to be applied to the more wide blade part of the stick.

An example embodiment of the present disclosure is directed to an item of sports equipment having visual images of highlights and important moments of an athlete's career and/or experience applied to an equipment used in the sport played by the athlete. Visual images applied to the sports equipment may be photographs, drawings, paintings, renderings, and the like without straying from the scope of the invention. In a particular embodiment, the present disclosure may involve a method of producing and applying the visual images to the equipment via a vinyl or other polymer wrap.

In one embodiment, a sports equipment is provided. The sports equipment has a body shaped to define the structure of the particular item. The body varies in shape having different widths and lengths, such as a traditional hockey stick, baseball bat, and the like. A polymer layer is applied to a surface of the body and is wrapped around the body and adhered there to. The polymer layer has depictions relating to a particular player such as photographs or images (drawings, paintings, sketches, and so on) as well as optionally statistics, player name, dates, key events, and the like. In some embodiments, the polymer layer may be disposed on the body of the sports equipment in multiple layers. This provides a more robust visual impression, reinforcing the colors and providing more body to the overall impression of the images on the body of the sports equipment. Further, additional layers more securely hold the polymer to the sports equipment.

In a particular embodiment, the polymer may be wrapped around the body in three layers. In a further embodiment, the polymer may be formed as a sheet and have the printed graphics applied only to a portion or strip along the sheet. In an embodiment, the depictions are printed or otherwise disposed on only ⅓ of the width of the polymer sheet layer and along its entire (or nearly entire) length.

In some embodiments, the polymer layer may have one or more adhesive strips or areas on a bottom surface. The adhesive aids in securing the polymer layer having the depictions thereon to the sports equipment and/or to itself. In some cases, contact paper may be laid over the adhesive and removed prior to application to the sports equipment.

In a further embodiment, this disclosure contemplates a computerized system for creating a composition of images depicting a career of an athlete for disposition on an item of sports equipment. Specifically, the computer system and process provides for a way to upload and arrange photos, drawings, and other graphics, along with text for fitting on the sports equipment. The computer system is further specifically operable to automatically adjust and modify the uploaded graphics content to fit properly on the sports equipment. In one embodiment, the computer system may include a non-transitory computer readable medium having instructions allowing and instructing a central processing unit (“CPU” or “processor”) to carry out the steps required during messaging, as described herein. This non-transitory computer readable medium may be stored within a housing of a computing device, or may be accessible through an electronic communication systems, such as a network. When used herein the term “computing device” means any electronic device having a processor, memory, and a graphical user interface (“GUI”) display, including, but not limited to, a cellular phone, a tablet, a laptop, or a desktop. Also, when used herein the term “network” refers to any system of interconnected electronic devices, such as, a cellular communication network or the Internet. Connections in the network may be wired or wireless.

In most embodiments, the computer system may require users to log in to a computerized and networked platform that prompts users to create a profile, which may include, creating a username and password, and providing the system with other relevant information. The computer system may then be operable as noted above through a remote or local user interface.

The computer system may include a computing device, which serves as the core processing unit. The computing device comprises essential components, including, but not limited to, a central processing unit or processor and a memory. The central processing unit is responsible for executing various instructions and performing computational tasks. The memory stores instructions and data that are essential for the operation of the computer system. These stored instructions are executed by the processor during system operation.

The immediately foregoing example presents a technical problem specific to the field of computer systems that is solved by the present disclosure. The technical problem that is being referred to is the difficulty when image processing to arrange graphics such that when applied to the varied and curved/inconsistent shape of sporting equipment, they are not distorted and fit properly on the item. Image manipulation and processing is very difficult and requires complex algorithms to transpose them on uneven surfaces. Thus the present invention improves the functioning of the computer by adapting the graphics to fit the sporting equipment item. Further still, the system applies transformation functions to the image(s) and graphics therein. These computerized transformation functions may be used to change images and images files into second image files specifically configured to fit onto an item of sporting equipment. Transformation functions include, but are not limited to rotating, shifting, mirroring, filtering, distorting, shrinking or expanding, smoothing and/or contrast increase or reduction, and cropping.

In one aspect, a computerized system for creating a composition of images depicting a career of an athlete for disposition on an item of sports equipment is provided. The system includes a computing device which has a memory and a processor. The memory stores instructions and the processor is operable to execute the instructions. The system has a user interface which is connected to the computing device. The processor is operable to cause the system to receive input image data (i.e. photos, drawings, sketches, and the like), receive an arrangement suggestion (i.e. a user can arrange these images, graphics, and text relative to each other in a manner the user desires as a suggestion and starting point for the system, on the user interface display), and receive a sports equipment type selection (i.e. a hockey stick, a baseball bat, a basketball, and so on). The system may then be operable to combine the received input image data and arrangement suggestion into a first image data file and store this file to the memory. The system may then apply one or more transformations using transformation algorithms to the first image data file which creates a second image data file based on the received sports equipment type selection. The second image data file is modified/transformed in shape from the first image data file to fit on the sports equipment and the individual graphics of the first image data file are scaled, shaped, cropped, and/or rearranged to fit on the item of sports equipment. The second image data file is then saved to the memory for later use.

In some further embodiments, the system may automatically send the second image data file to a printer which can dispose the second image data file on a polymer film wrap, print the graphics directly on a sports equipment, and the like.

In a particular embodiment for use with a shrink-wrap polymer sheet, it is to be expected that certain areas may shrink more than other areas based on the size of the portion of the sports equipment item. For example, on a baseball bat, the barrel is thicker than the taper and handle, and thus there will be less shrinking of the film at the barrel than at the taper and handle. As such, the step of applying transformations may comprise adjusting a size of one of the plurality of images in the first image data file. A similar size adjustment may be used in other embodiments to accommodate for variation in size on the sports item. For example, a graphic may be made smaller to fit on the taper portion of a baseball bat because it would otherwise be too big.

A method of use of the system may involve compiling art work into a first image file, applying the above noted transformations to the first image file to create a second image file, and then printing this second image file. The printing may be onto a polymer sheet for disposition on the sports equipment item, may be directly disposed on the item, or the like.

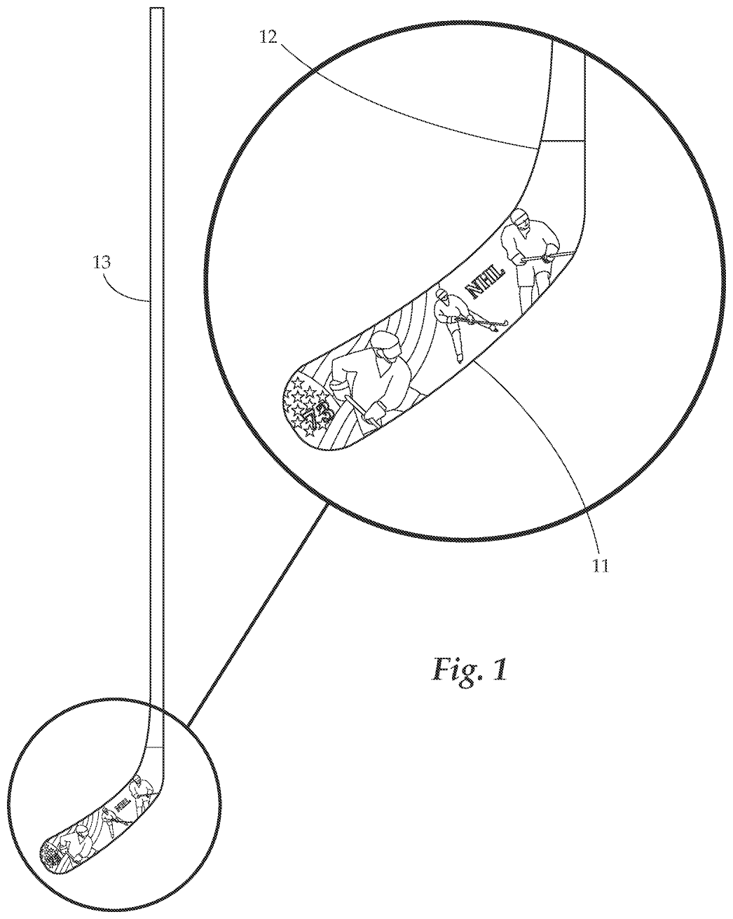

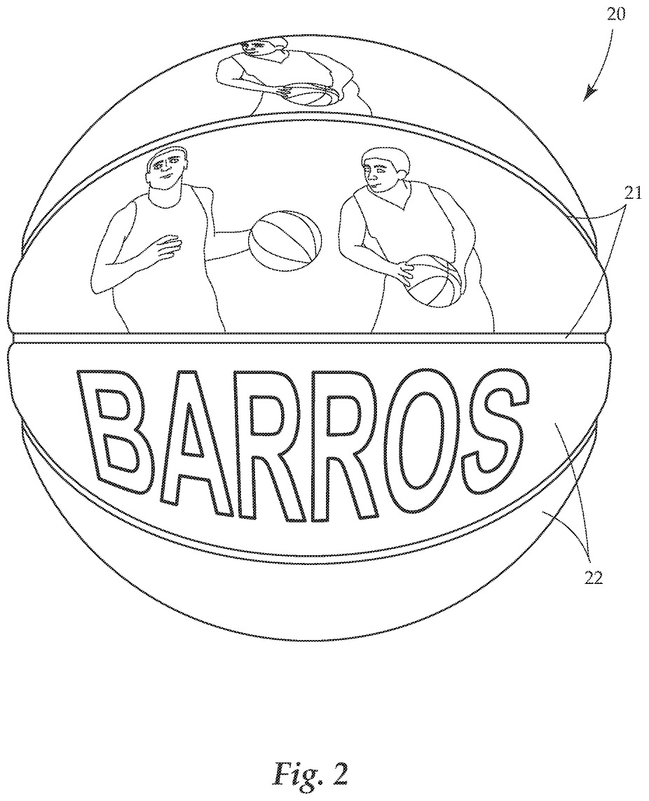

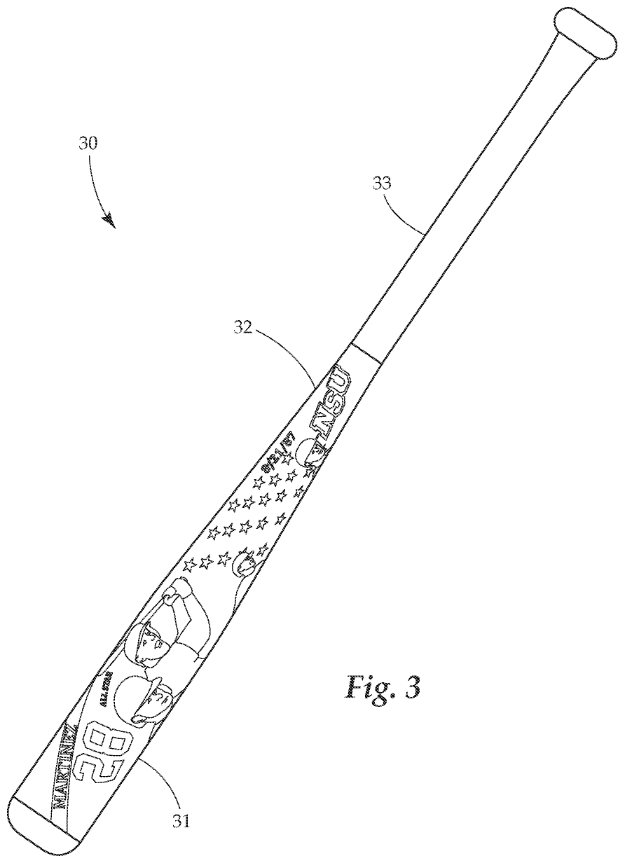

Turning now to FIG. 1 provides a view of a hockey stick having the depictions of a career of a hockey player disposed thereon. The hockey stick has a blade 11 with a wide portion for display of depictions, neck 12 is more narrow and requires smaller graphics, and the handle 13 of the stick is quite narrow with minimal space. The depictions must adjust in scale and orientation to fit along the hockey stick. The player may be a professional, amateur, youth athlete, and the like. Similarly, FIG. 2 shows a basketball 20 with depictions thereon. The thicker area 22 allows for bigger images compared to the more narrow area 21. FIG. 3 shows an embodiment of the depictions on a baseball bat 30. The barrel 31 of the bat accommodates larger images compared to the more narrow taper 32.

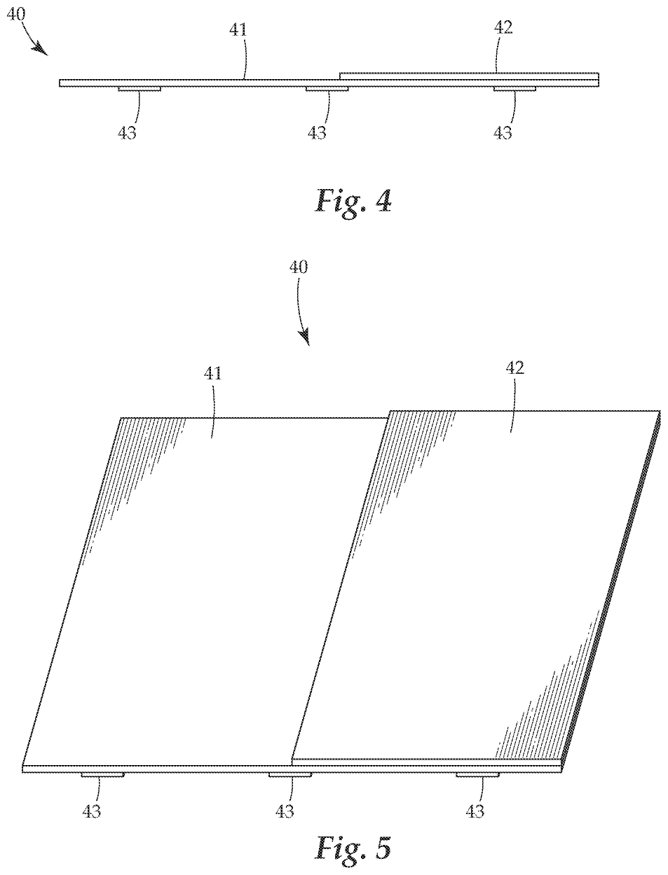

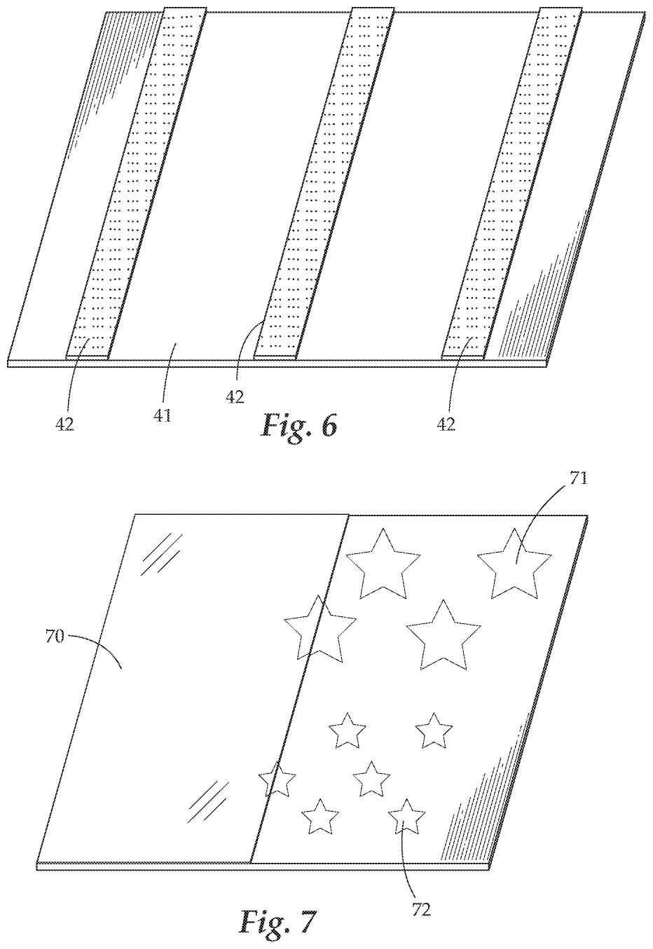

FIGS. 4 and 5 show an embodiment of a sheet of polymer material having graphics disposed thereon for attachment to a sports equipment item. The sheet 40 has a top surface 41 and a printed section 42 with only a portion of the top surface 41 coated with the printed portion. This allows for wrapping multiple layers with the printed section 42 on the top layer of the finished product. In other embodiments, just a single layer may be applied and the printed section 42 may cover all or most of the top surface 41. In another embodiment, the printed section 42 may be covered by a transparent sheet 40 to protect the printed section with another layer or layers of the sheet 40. On a bottom surface of the sheet 40 are a plurality of adhesive strips 43. In shrink wrap embodiments, these adhesive strips 43 may be omitted. FIG. 6 provides a similar embodiment to that of FIGS. 4 and 5 with two printed areas 42. These are configured to create a two layer appearance so that there are two printed layers on top of each other to reinforce the coloring and appearance of the depictions.

FIG. 7 provides a view of a polymer sheet 70 which has varying sized depictions on a shrink wrap sheet. Smaller images 72 will be disposed over a larger area portion such as a barrel of a bat, as they will shrink less. Meanwhile, the larger images 71 will be disposed over the smaller area, such as a taper or handle of a baseball bat and when shrunk, will have a similar size to the smaller images 72 because this area will shrink more to fit the smaller diameter/perimeter parts.

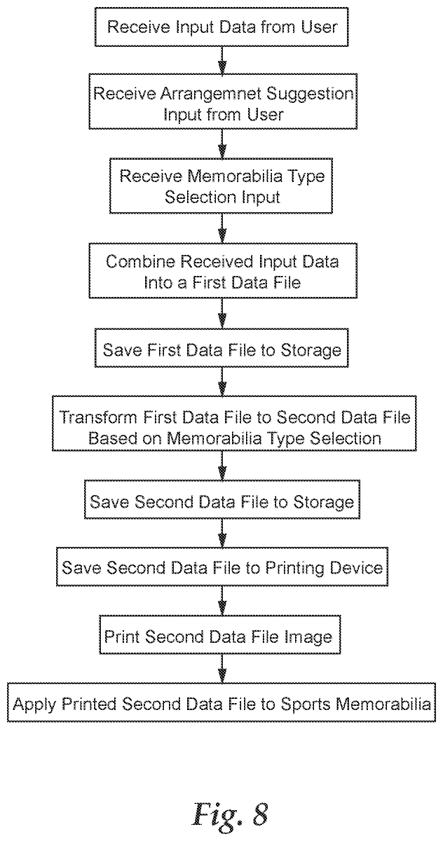

FIG. 8 provides a flow chart of an embodiment of computerized system use herein. The system receives input data which is image and text data (i.e. photos, drawings, sketches, and the like), receive an arrangement suggestion (i.e. a user can arrange these images, graphics, and text relative to each other in a manner the user desires as a suggestion and starting point for the system, on the user interface display), and receive a sports equipment type selection (i.e. a hockey stick, a baseball bat, a basketball, and so on). The system can then combine the received input image data and arrangement suggestion into a first image data file and save this file to the memory storage. The system may then apply one or more transformations using transformation algorithms to the first image data file which creates a second image data file based on the received sports equipment/memorabilia type selection. The second image data file is modified/transformed in shape from the first image data file to fit on the sports equipment and the individual graphics of the first image data file are scaled, shaped, cropped, and/or rearranged to fit on the item of sports equipment. The second image data file is then saved to the memory storage for later use. Further, the system may then print the second data file image. This printing may be applied directly to the sports equipment item, or to a sheet or wrap for later application after printing is completed.

While several variations of the present disclosure have been illustrated by way of example in preferred or particular embodiments, it is apparent that further embodiments could be developed within the spirit and scope of the present disclosure, or the inventive concept thereof. However, it is to be expressly understood that such modifications and adaptations are within the spirit and scope of the present disclosure, and are inclusive, but not limited to the following appended claims as set forth.

What is claimed is:

1. A sports equipment comprising:
a body of the sports equipment, the body having a varying shape;
a polymer layer applied to a surface of the body and wrapping around the body and being adhered to the body;
the polymer layer comprising depictions of a career of an athlete comprising images and statistics.

2. The sports equipment of claim 1 wherein the polymer layer is disposed in three wrapped layers around the body.

3. The sports equipment of claim 2 wherein the polymer layer is a sheet, and wherein the depictions are only disposed on approximately one third of a width of the polymer layer and disposed on the length of the polymer layer.

4. The sports equipment of claim 3 wherein the polymer layer sheet comprises three strips of adhesive on a bottom surface.

5. The sports equipment of claim 3 wherein the depiction has larger graphics at a first end and smaller graphics at a second opposite end to accommodate for a shrinking of the polymer layer to adhere it to the body of the sports equipment.

6. The sports equipment of claim 1 wherein the sports equipment is one of a hockey stick, a football, a soccer ball and a basketball.

7. A computerized system for creating a composition of images for disposition on a sports equipment comprising:
a computing device comprising a memory and a processor, the memory storing instructions and the processor operable to execute the instructions;
a user input connected to the computing device; and
wherein the processor is operable to perform the steps of:
receiving input image data;
receiving an arrangement suggestion of the input image data;
receiving a sports equipment type selection input;
combining the received input image data into a first image data file;
saving the first image data file to the memory;
applying one or more transformations to the first image data file to create a second image data file based on the received sports equipment type selection input;
saving the second image data file.

8. The system for creating a composition of images for disposition on a sports equipment of claim 7 wherein the processor is further operable to perform the step of sending the saved second image data file to a printer.

9. The system for creating a composition of images for disposition on a sports equipment of claim 7 wherein the applying one or more transformations includes applying one or more of rotating, shifting, mirroring, filtering, distorting, shrinking, expanding, smoothing, contrast increase, contrast reduction, and cropping.

10. The system for creating a composition of images for disposition on a sports equipment of claim 7 wherein the applying one or more transformations includes transforming a shape of the first image data file to a shape corresponding to the received sports equipment type selection.

11. The system for creating a composition of images for disposition on a sports equipment of claim 7 wherein the receiving input image data comprises receiving a plurality of photographs and drawings.

12. The system for creating a composition of images for disposition on a sports equipment of claim 11 wherein the receiving the arrangement suggestion input comprises receiving an input arranging the plurality of photographs and drawings relative to each other in the first image data file.

13. The system for creating a composition of images for disposition on a sports equipment of claim 11 wherein the applying one or more transformations comprises adjusting a size of one of the plurality of photographs and drawings relative to a second of the plurality of photographs and drawings to accommodate for an expected shrinking of a printed second image file when being disposed on the sports equipment.

14. The system for creating a composition of images for disposition on a sports equipment of claim 11 wherein the applying one or more transformations comprises adjusting a size of one of the plurality of photographs and drawings relative to a second of the plurality of photographs and drawings to accommodate for an variation in shape of the sports equipment.

15. A method of forming and printing an image file on a polymer sheet for disposition on a sports equipment comprising the steps of:
compiling art work into a first image file;
applying one or more transformations to the first image data file to create a second image data file based on a sports equipment type and size, the one or more transformations re-sizing and re-orienting the art work of the first image file into a size and orientation fittable to the sports equipment;
printing the second image data file onto at least a portion of a polymer layer;
attaching the polymer layer to the sports equipment.

16. The method of claim 15 wherein the step of attaching comprises adhering the polymer layer to the sports equipment.

17. The method of claim 15 wherein the step of attaching comprising shrink wrapping the polymer layer to the sports equipment.

18. The method of claim 17 wherein the step of applying one or more transformations comprises adjusting a size of the artwork of the first image file based on an expected shrinking of the polymer layer during the step of shrink wrapping.

19. The method of claim 15 wherein the step of applying one or more transformations includes applying one or more of rotating, shifting, mirroring, filtering, distorting, shrinking, expanding, smoothing, contrast increase, contrast reduction, and cropping, and wherein the transformations cause the art work of the first image file to be fittable to the shape of the sports equipment.

20. The method of claim 15 wherein the step of attaching comprises wrapping multiple layers of the polymer layer around the sports equipment and wherein the step of printing comprises printing on a portion of the polymer layer that is less than 50% of the surface area of the polymer layer.
